(19) United States
(12) Patent Application Publication
(10) Pub. No.: US 2010/0332224 A1
(43) Pub. Date: Dec. 30, 2010

(54) METHOD AND APPARATUS FOR CONVERTING TEXT TO AUDIO AND TACTILE OUTPUT

(75) Inventors: Jakke Sakari Mäkelä, Turku (FI); Jukka Pekka Naula, Piispanristi (FI); Niko Santeri Porjo, Piikkio (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/494,516

(22) Filed: Jun. 30, 2009

(51) Int. Cl. G10L 13/08; G10L 15/00

(52) U.S. Cl. 704/231; 704/260; 704/E13.011; 704/E15.001

(57) ABSTRACT

In accordance with an example embodiment of the present invention, an apparatus comprises a controller configured to process punctuated text data, and to identify punctuation in said punctuated text data; and an output unit configured to generate audio output corresponding to said punctuated text data, and to generate tactile output corresponding to said identified punctuation.

### TECHNICAL FIELD

The present application relates generally to a method and apparatus for converting text to audio output and tactile output.

### BACKGROUND

Communication devices, such as mobile phones, are now part of daily life, and device manufactures continue to strive for enhanced performance. Such devices typically use auditory and visual techniques of communicating data. However, it is not always possible for users to engage in visual means of communication, for example if they are driving, or if they have a visual disability. Also if they are in a noisy environment then this can impair the effectiveness of auditory methods. Some devices also use speech synthesis programs to convert written input to spoken output using synthetic speech and speech synthesis. The synthetic speech is typically referred to as text to speech conversion (TTS). Despite the use of TTS, these devices are still limited.

### SUMMARY

Various aspects of the invention are set out in the claims. In accordance with an example embodiment of the present invention there is provided an apparatus comprising: a controller configured to process punctuated text data and to identify punctuation in the text data; an output unit configured to convert text data to audio output and to convert the identified punctuation to tactile output.

In the context of embodiments of the present invention, the term “punctuation” should be interpreted broadly to encompass everything in written text other than the actual letters or numbers. In general, punctuation may include punctuation marks, inter-word spaces, indentations and/or the like.

Punctuation marks are in general symbols that correspond neither to the phonemes or sounds of a language nor to the leximes, the words and/or phrases, but are elements of the written text that serve to indicate the structure and/or organization of the writing. Punctuation marks may also indicate the intonation of the text and/or pauses to be observed when reading it aloud. Thus, punctuation may be considered to comprise any element of written text that may not be spoken when the text is read aloud, but which may add meaning, help a listener to interpret the text, for example when more than one alternate meanings are possible, or understand its organization. For example, punctuation may comprise a symbol that communicates a pause in the audio output, an interrogatory, an exclamation and/or the like. Punctuation may also comprise a symbol that conveys an emotion associated with the text, such as an emoticon. Punctuation may play a role in enhancing the intelligibility of the written or spoken text.

Under the foregoing definition, it is intended therefore that the present inventive concept should apply to the provision of tactile output to indicate any property of written text that may not be apparent when the text is read aloud, incorporating elements conventionally thought of as punctuation, as well as aspects relating to the appearance of the text, for example highlighting, capitalization, underlining, emboldening or italicization, indentation, text formatting, bullet points and/or the like. The term “unspoken aspects” will be used to denote this concept.

The written form and arrangement of punctuation marks, as well as the formal rules for their use, may differ from one language to another. However, it should be understood that the inventive principles described in the detailed description of this disclosure may be applied to any language in which punctuation is used. Taking the English language as an example, written using the modern Latin alphabet, commonly used punctuation marks comprise one or more of: period, comma, question mark, colon, semi-colon, exclamation mark, hyphen, quotation mark, or apostrophe, as well as many other punctuation marks. Similar symbols may be used in other languages that are based on different alphabets. These include, but are not limited to, Slavic languages which use the Cyrillic alphabet, and languages such as Chinese, Korean, Japanese and Arabic that are based on different writing systems. In addition, many languages comprise punctuation marks different from those used in English. Embodiments of the invention may therefore be devised which are specific to a given language, or which may be used for a specific group of languages that use the same or related punctuation.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram of an apparatus for converting text to audio and tactile output, in accordance with an example embodiment of the invention;

FIG. 2 is a block diagram depicting components of an electronic device incorporating the apparatus of FIG. 1, in accordance with an example embodiment of the invention;

FIG. 3 is a 3-dimensional schematic diagram depicting the external appearance of the electronic device of FIG. 2;

FIG. 4 is a schematic diagram of a tactile actuator, which may form part of the apparatus shown in FIG. 1, in accordance with an example embodiment of the invention;

FIG. 5 is a flow diagram illustrating a method for processing text data into a phoneme stream and a punctuation stream, in accordance with an example embodiment of the invention; and

FIG. 6 is a flow diagram illustrating a method for processing a phoneme stream to generate audio output, and a punctuation stream to generate tactile output, in accordance with an example embodiment of the invention.

### DETAILED DESCRIPTION OF THE DRAWINGS

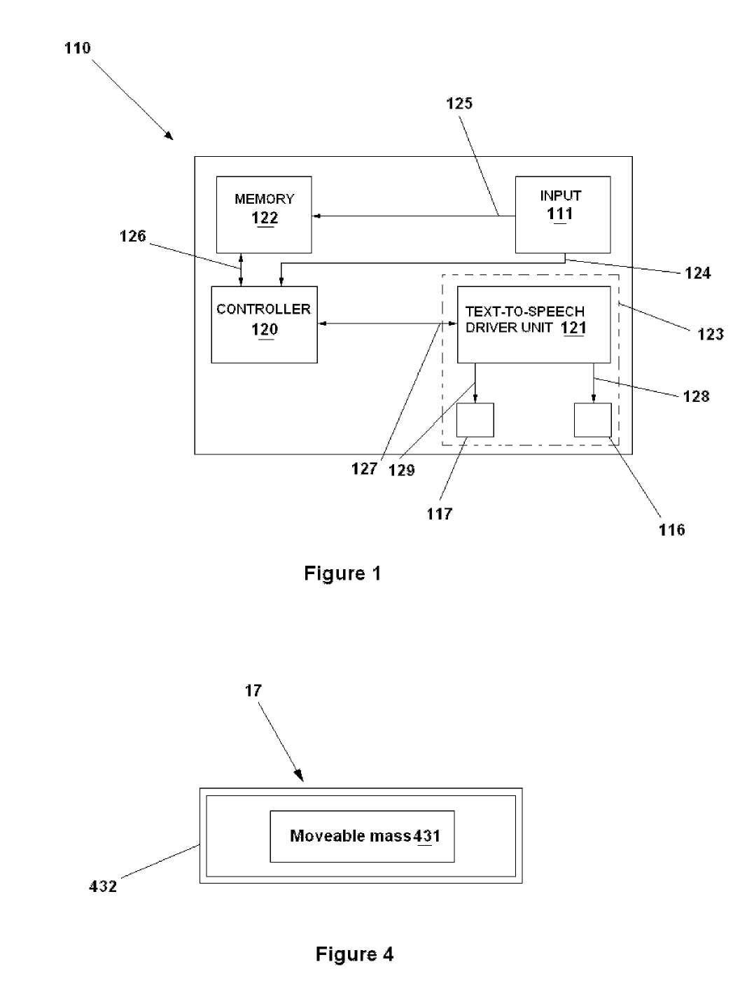

Example embodiments of the present invention and their potential advantages are understood by referring to FIGS. 1 through 6 of the drawings.

FIG. 1 is a block diagram of an apparatus for converting text to audio and tactile output in accordance with an example embodiment of the invention. The apparatus, denoted in FIG. 1 by reference numeral 110, comprises an input unit 111, a controller 120, a memory 122, and an output unit 123. Output unit 123 comprises a text-to-speech output driver unit 121, an audio output unit 116, for example a loudspeaker or other suitable device capable of producing an audible output signal, and a tactile output unit 117. The tactile output unit 117 may comprise any suitable mechanism capable of providing a perceivable tactile effect.

Input unit 111 is configured to receive data representative of punctuated text and to provide the received punctuated text data to controller 120, via logical connection 124. In an alternative embodiment, input unit 111 may be configured to transmit the punctuated text data to memory 122, via logical connection 125, the memory 122 being configured to store the punctuated text data, at least temporarily. In such an embodiment, the punctuated text data may be retrieved from the memory 122 by the controller 120 via logical connection 126.

In embodiments of the invention, the punctuated text data may form part of a message, for example a short text message (see, for example, Global System for Mobile Communications (GSM) standard GSM 03.40 v.7.5.0 “Technical Realisation of Short Message Service (SMS)”), an e-mail message, a multi-media message (see for example 3rd Generation Partnership Project (3GPP) standard 3GPP TS 23.140 “Multimedia Messaging Service: Functional Description”), a fax message and/or the like.

In other embodiments, the punctuated text data may be received as input from a user input device such as a keyboard, a user interface comprising a touch screen configured for text entry or handwriting recognition. In still further embodiments, the punctuated text data may be generated, for example, as a result of an optical character recognition operation (OCR) performed on a scanned image containing written text.

Considering embodiments in which the punctuated text data may form part of a message, certain types of message, such as e-mail messages and multimedia messages may contain non-textual elements such as audio clips, still pictures, or video in addition to textual content. Fax messages may contain images in addition to text. Therefore, in embodiments of the invention where punctuated text data may be present in a message together with other media types, such as audio, still pictures or video, input unit 111 may be configured to examine the message to identify those parts of the message that correspond to textual content. Taking an e-mail message as an example, according to Internet Engineering Task Force (IETF) Request for Change (RFC) 2045 “Multi-Purpose Internet Mail Extensions (MIME) Part One: Format of Internet Message Bodies” (November 1996) and RFC 2046 “Multi-Purpose Internet Mail Extensions (MIME) Part Two: Media Types” (November 1996), the presence of different media types in an e-mail message may be indicated by means of a “Content-Type” header field. The Content-Type header field may specify not only the type of media content present within the message, but may also provide information about its format. In an embodiment, input unit 111 may be configured to examine an e-mail message to identify an element or elements of the message identified as “Text” by a Content-Type header or headers. Responsive to identifying particular parts of a received message corresponding to textual content, input unit 111 may be configured to provide only those parts of the message identified as corresponding to textual content to controller 120.

In situations where the message does not already contain an indication or indications that a certain part or parts of the message correspond to textual content, input unit 111 may be configured to provide such an indication or indications in the message.

In alternative embodiments, input unit 111 may be configured to remove from a message all elements that do not correspond to textual content, or to otherwise mark those elements to indicate that they should be not converted to audio and tactile output.

In certain embodiments, input unit 111 may further be configured to examine parts of a received message identified as corresponding to textual content in order to identify any part or parts of the text not to be converted to audio and tactile output. The input unit may be configured to remove any identified parts so as to leave only punctuated text data for which conversion into audio and tactile output is to be performed. Alternatively, the input unit may be configured to mark or otherwise indicate any part or parts of the text not to be converted. Again, taking e-mail as an example, input unit 111 may be configured to examine an e-mail message to identify any MIME-type header fields from within the body of the message and to remove the characters representative of the header field or fields from the message.

In certain embodiments, input unit 111 may further be configured to identify an encoding scheme used to represent the punctuated text data. The encoding scheme in use may be dependent upon or otherwise determined by the language of the punctuated text. For example, the punctuated text may be represented with codewords assigned according to the American Standard Code for Information Interchange (ASCII), which represents each character of the English alphabet, as well as numerous punctuation marks, using a 7-bit codeword. Alternatively, the punctuated text may be represented with codewords assigned according to one of the 7-bit national-language equivalents of the ASCII system, defined according to International Organisation for Standardisation (ISO)/International Electrotechnical Commission (IEC) standard number ISO/IEC 646. Another possibility is, for example, that the punctuated text data is Russian language text represented by the “Kod Obmena Informatsiey, 7 bit”, standard (Ko/ [symbol] [symbol] [symbol] 7 [symbol] ), known as KOI7, which assigns 7-bit codewords to Cyrillic characters. As each of the aforementioned encoding schemes is a 7-bit encoding scheme with 128 possible codewords, none of them can represent all characters that might be used in all languages. 8-bit encoding schemes, with 256 available codewords, allow a larger number of characters to be represented and thus provide possibilities to devise encoding schemes that may be used for more than one language or language family. However, 256 codewords may still be too few to represent all desired characters. ISO standard 8859 “8 Bit Single-Byte Coded Graphic Character Sets”, for example, seeks to address this issue by providing 16 different 8-bit encoding schemes, each intended principally for a particular language or group of languages.

Thus, each encoding scheme makes its own assignment of data symbols or values to textual characters, resulting in a situation in which the same codeword may represent a different character, depending on the encoding scheme used. Thus, identification of the encoding scheme may assist in correct identification of the characters represented by the punctuated text data, as well as unspoken aspects of the text, such as punctuation marks, for example.

In certain embodiments, input unit 111 may be configured to determine the encoding scheme used to represent the punctuated text by examining encoding mode information provided in association with the punctuated text data. In an example embodiment, in which the punctuated text data is provided in a short message according to the GSM standards, for example, information about the encoding scheme used to represent the text can be found from the “TP-data-coding-scheme” field of the message (see for example, GSM standard document 03.38 v.7.2.0, “Alphabets and Language-Specific Information”, section 4, “SMS Data Coding Scheme”). Thus, in this embodiment, input unit 111 may be configured to examine the TP-data-coding-scheme field of an SMS message to determine the encoding mode of punctuated text data within the message.

In example embodiments, in which the punctuated text data is provided in an e-mail message, input unit 111 may be configured to obtain information about the encoding scheme used to represent the punctuated text from a header portion of the e-mail message. Again referring to IETF RFCs 2045 and 2046, and specifically Section 4.1.2 of RFC 2046, the Content-Type header field may contain a “charset” (character set) parameter, which identifies the encoding scheme (e.g. character set) used to represent the punctuated text. Thus, input unit 111 may be configured to determine the encoding scheme used to represent a particular section of punctuated text within an e-mail message by locating and reading the charset parameter associated with that section of text.

In alternative embodiments, input unit 111 may be configured to obtain information about the language of the punctuated text data and, responsive to identification of the language or languages used, apply a predetermined assumption concerning the encoding scheme used to represent the punctuated text. For example, input unit 111 may be configured to determine the language of the punctuated text data and responsive to determination of the language used, to assume use of an encoding scheme according to one of the national-language equivalents of the ASCII system defined by ISO/IEC 646. Alternatively, if the punctuated text data comprises sections in one or more different languages, input unit 111 may be configured identify the language associated with each part of the punctuated text data and to apply a corresponding default assumption concerning the encoding scheme used for each section.

In an example embodiment, in which the punctuated text data is provided in an e-mail message, input unit 111 may be configured to obtain information about the language of the punctuated text data from the Content-Language field of an e-mail header. The Content-Language field is another e-mail header field (see IETF RFC 4021 “Registration of Mail and MIME Header Fields” (March 2005), Section 2.2.10). According to RFC 4021, the Content-Language field may contain one or more “tags”, for example “en” for English, “fr” for French, which indicate the language or languages used in a message. The tags may take any of the forms defined in IETF RFC 1766. According to RFC 1766, a tag representative of a particular language may be associated with a part of a message. In an embodiment, input unit 111 may be configured to identify the language used in different sections of the punctuated text data with reference to language tags provided in an e-mail message and to make corresponding assumptions concerning the encoding scheme used to represent the punctuated text.

In still other alternative embodiments, input unit 111 may be configured to infer or assume use of a certain encoding scheme in dependence upon a language setting of the apparatus. The language setting may be pre-set at the time of manufacture of the apparatus, or alternatively may be user selectable. For example, input unit 111 may be configured to receive input from a user of the apparatus. The user input may take the form of a direct indication of an encoding scheme used to represent the punctuated text. Alternatively, the user input may indicate a language or languages used in the punctuated text data. Input 111 may be configured to make a corresponding assumption concerning the encoding scheme or schemes used to represent the punctuated text responsive to the language or language indicated by the user input.

Returning to consideration of FIG. 1, controller 120 is configured to receive the punctuated text data for conversion into audio and tactile output and to provide the punctuated text data to text-to-speech driver unit 121 via logical connection 127.

In embodiments of the invention, text-to-speech driver unit 121 may be configured to accept punctuated text data encoded using any of a predetermined number of different encoding schemes. In these embodiments, controller 120 may be configured to recognise the encoding scheme in use and to provide the text-to-speech driver unit 121 with an indication of the encoding scheme used to represent the punctuated text data. For example, text-to-speech driver unit 121 may be configured to recognise punctuated text data comprising codewords assigned according to any one, or more than one, of the 16 language-specific 8-bit representations defined according ISO recommendation ISO 8859. In such an embodiment, controller 120 may be configured to provide the punctuated text data to text-to-speech driver unit 121 together with a corresponding indication of a particular one of the 16 different encoding schemes provided under the ISO 8859 standard.

In alternative embodiments, text-to-speech driver unit 121 may be configured to receive punctuated text data in a predetermined format and controller 120 may be configured to perform a conversion operation in order to convert the punctuated text data received from the input unit 111 from the format in which it received from input unit 111 into a format suitable for processing by the text-to-speech driver unit 121. In an example embodiment, the text-to-speech driver unit 121 may be configured to accept punctuated text data comprising codewords assigned according to the so-called “Unicode Standard” developed by the Unicode Consortium and documented in the ISO/IEC Standard 10646 “Universal Multiple-Octet Coded Character Set (UCS)”. The Unicode Standard defines a codespace of 1,114,112 codepoints in the range 0ₕₑₓ to 10FFFFₕₑₓ where the subscript “hex” denotes hexadecimal numerical notation. The codepoints are arranged in 17 planes of 256 rows, each containing 256 codepoints. The Unicode Standard is therefore capable of representing many more characters than the other previously-mentioned encoding schemes. In fact, at the time of writing, version 5.1 of the Unicode standard provides representations of 75 different writing systems. Thus, in embodiments in which the text-to-speech driver unit is configured to recognize text represented according to the Unicode Standard, controller 120 may be configured to convert the punctuated text data received from input unit 111 into codepoints of the Unicode Standard. The punctuated text data may then be provided to the text-to-speech driver unit in the format it recognizes and can process further to produce audio and tactile output.

In embodiments of the invention, upon receiving punctuated text data in a format that cannot be recognised by the text-to-speech driver unit, controller 120 may be configured to provide a corresponding error indication. This indication may be presented to a user by means of a display or audible error signal, thereby informing the user that that the punctuated text data is in a format that cannot be processed into audio and tactile output.

In still further embodiments, controller 120 may be configured to pass the punctuated text data to the text-to-speech driver unit without changing the format of the punctuated text data and appropriate format conversion may be performed by the text-to-speech driver unit itself.

Text-to-speech driver unit 121 is configured to receive the punctuated text data from the controller via logical connection 127. It is further configured to process the punctuated text data to identify any data symbols representative of punctuation marks or any other indications representative of unspoken aspects of the punctuated text data. In an example embodiment, text-to-speech driver unit 121 is configured to identify unspoken aspects in the punctuated text data by comparing each data value or symbol of the received text data with a predetermined set of corresponding data values or symbols known to be representative of particular unspoken aspects of text for which tactile output is to be provided. For example, in an embodiment in which the text-to-speech driver unit is configured to operate on punctuated text data represented by ASCII codes, punctuation marks in the punctuated text data can be identified by comparing each ASCII symbol of the punctuated text data with the codes known to represent punctuation marks for the language in question under the ASCII system. Formatting of the text and other aspects such as underlining, indentation and/or the like may be identified, for example, by searching for possible control codes associated with those aspects from within the punctuated text data.

The set of corresponding data values or symbols with which the text-to-speech driver unit compares the punctuated text data may be stored in memory 122, for example, and may take the form of a look-up table. In an example embodiment, the set of corresponding data values or symbols may be representative of all possible unspoken aspects, comprising all punctuation marks that may be used in a single predetermined language and all other possible unspoken aspects such as capitalization, underlining, emboldening or italicization, indentation, text formatting, bullet points and/or the like. In an alternative embodiment, the predetermined set may represent a pre-selected sub-set of all available unspoken aspects for a particular language, for example punctuation marks only. In a further alternative embodiment, more than one set of corresponding data values or symbols may be provided, one for each of a predetermined number of different languages. In an example embodiment, the sets of corresponding data values or symbols for each predetermined language may be stored as separate individual look-up tables. In alternative embodiments, the sets of corresponding data values or symbols for different languages may be stored in a single table with separate entries for each different language. In such an embodiment, a degree of overlap may be allowed between the entries for different languages to account for the fact that the same or similar punctuation marks may be used in the same family of languages or related families of languages. This may enable storage space to be saved in memory 122. However, such overlapping of entries for different languages may not be possible in all embodiments since, for example, similar punctuation marks in different languages may be represented by different ASCII codes.

In an embodiment of the invention, text-to-speech driver unit 121 may be configured to identify punctuation within the punctuated text data by interpreting every data symbol in the punctuated text data that does not correspond with phonemes and or leximes as an element of punctuation. In this case, the text-to-speech driver unit may be configured to check that the identified data symbols do indeed correspond to recognised punctuation marks. This may be done by reference to a pre-stored look-up table of recognised punctuation marks stored in memory 122. Alternatively, text-to-speech diver unit may be configured to identify Responsive to the identified symbols and/or indications, text-to-speech driver unit 121 is configured to form a corresponding punctuation information signal that is representative of the identified punctuation and to provide the punctuation information signal to the tactile output unit 117 via logical connection 129. The text-to-speech driver unit is further configured to process the punctuated text data to form a synthetic speech signal and to provide the synthetic speech signal to the audio output unit 116 via logical connection 128.

Audio output unit 116 is configured to receive the synthetic speech signal and to produce an audible speech signal representative of the punctuated text data responsive to the received synthetic speech signal. Responsive to the punctuation information signal received from text-to-speech output driver unit 121, tactile output unit 117 is configured to produce a perceivable tactile output representative of the punctuation identified in the punctuated text data. In an embodiment of the invention, tactile output unit is configured to produce a uniquely identifiable tactile stimulus for each different punctuation.

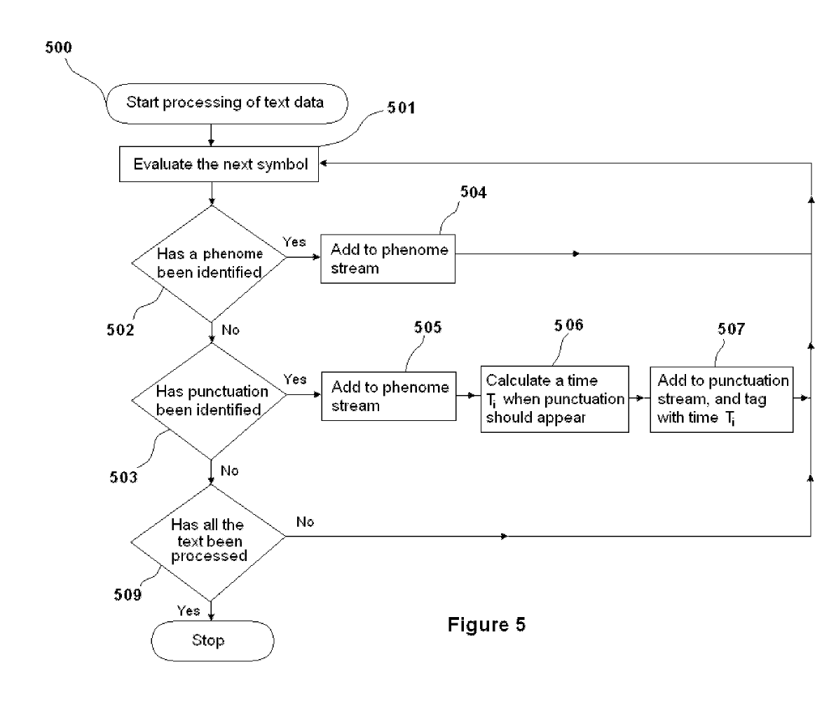

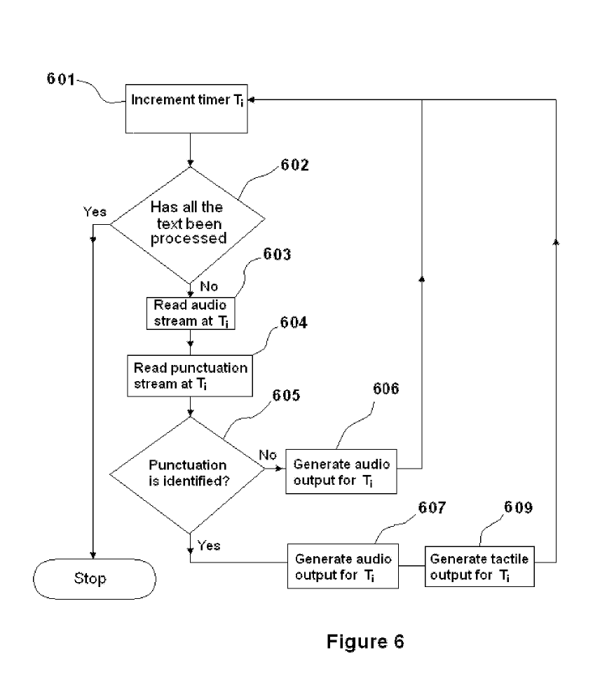

In an embodiment of the invention, text-to-speech output driver unit 121 is configured to control audio output unit 116 and tactile output unit 117 to synchronise the perceivable tactile output produced by the tactile unit with the audible speech signal produced by the audio output unit. This has the effect of causing tactile stimuli representative of punctuation marks within the text to be produced by the tactile output unit 117 at substantially the same time as audible punctuation effects, such as pauses and stops, occur in the audible speech signal produced by the audio output unit 116. This may have the technical effect of improving the intelligibility of the synthetic speech signal. This may be valuable in situations where the correct interpretation of the text is important, or in situations where there is a high level of environmental background noise, making it difficult for the synthetic speech signal to be heard. The synchronised tactile punctuation output may also improve the intelligibility of the synthetic speech for those with a hearing deficit, to produce a perceivable tactile output representative of the punctuation identified in the punctuated text data, as previously described. In an embodiment of the invention, text-to-speech output driver unit 121 is configured to control audio output unit 116 and tactile output unit 117 to synchronise the perceivable tactile output produced by the tactile unit with the audible speech signal produced by the audio output unit to identify data symbols representative of punctuation in said punctuated text data. In an alternative embodiment, input unit 111 is configured to provide the punctuated text data for processing directly to controller 120 via logical connection 124 (shown as a dotted line in FIG. 1) without the intermediate step of storage in the memory 122. The process of punctuation identification is described in more detail with regard to FIGS. 5 and 6.

The text-to-speech output driver unit 121 is configured to process the received punctuated text data to form a synthetic speech signal and to provide the synthetic speech signal to the audio output unit 116.

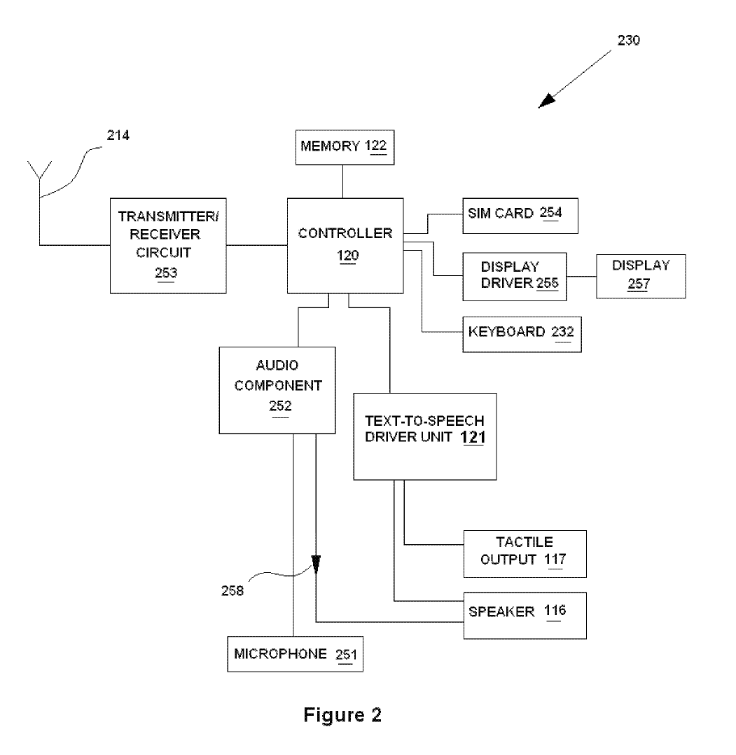

FIG. 2 is block diagram depicting components of an electronic device incorporating the apparatus of FIG. 1, in accordance with an example embodiment of the invention. In the example embodiment of FIG. 2, the device, denoted in general by reference numeral 230, is a radio handset. However, in alternative embodiments, the electronic device 230 may be a computer, for example, a personal computer PC, a personal digital assistant, PDA, a radio communications device such as a mobile radio telephone e.g. a car phone or handheld phone, a computer system, a document reader, such as a web browser, a punctuated text data TV, a fax machine, or a document browser for reading books, emails or other documents or any other device in which it may be desirable to produce tactile indication of punctuation in combination with an audible speech signal.

In FIG. 2, functional units of electronic device 230 that constitute elements of the apparatus for converting text to audio and tactile output, described in connection with FIG. 1, are given reference numerals corresponding to those used in FIG. 1.

As can be seen from FIG. 2, in the depicted embodiment, electronic device 230 comprises a controller 120, coupled to a transmitter-receiver unit 253, a text-to-speech driver unit 121 and an audio encoding-decoding unit 252. The device further comprises a memory 122, a SIM card interface 254, a display 257 coupled to a display driver 255, an audio input unit 251, an audio output unit 116, a tactile output unit 117 and a keyboard 232. In an embodiment of the invention, audio output unit 116 comprises a loudspeaker. In an embodiment of the invention, audio input unit 251 comprise a microphone.

In operation, the transmitter-receiver unit 253 is configured to transmit and receive radio-frequency transmissions via antenna 214. The transmitter-receiver unit 253 is further configured to demodulate and down-mix information signals received via antenna 214 and to provide the appropriately demodulated and down-mixed information signals to controller 120. Controller 120 is configured to receive the demodulated and down-mixed information signals and to determine whether the received information signals comprise encoded audio information (for example representative of a telephone conversation) or other information, such as data representative of punctuated text, for example a received short message (e.g. an SMS), an e-mail, or any other form of text-based communication.

Responsive to determining that a received information signal comprises encoded audio information, controller 120 is configured to pass the encoded audio information to the audio encoding-decoding unit 252 for decoding into a decoded audio signal that can be reproduced by audio output unit 116.

Alternatively, responsive to determining that a received information signal comprises data representative of punctuated text, controller 120 is configured to extract the punctuated text data from the received information signal and to forward the punctuated text data to the text-to-speech driver unit 121. In an embodiment, the controller is configured to convert the received punctuated text data into a format suitable for interpretation by the text-to-speech driver unit. For example, in a particular embodiment, the controller may be configured to provide the punctuated text data to the text-to-speech driver unit as a sequence of ASCII characters, each ASCII character being representative of a particular character of the punctuated text, including punctuation marks. In alternative embodiments, other appropriate representations may be used. For example, each character of the punctuated text may be represented by a predefined binary or hexadecimal code. In still further embodiments, the punctuated text data as extracted from the received information signal may already be in a format suitable for processing by the text-to-speech driver unit 121. In this case, controller 120 is configured to pass the punctuated text data to the text-to-speech driver unit 121 without any intermediate format conversion.

As described in connection with FIG. 1, in embodiments of the invention, controller 120 may be configured to process the punctuated text data to identify data symbols representative of punctuation in the punctuated text data and to provide the punctuated text data to the text-to-speech driver unit 121 together with a punctuation information signal representative of the punctuation identified in the punctuated text. In alternative embodiments, the text-to speech driver unit 121 may be configured to analyse the punctuated text data and to form the corresponding punctuation information signal. In the description of FIG. 2, it will be assumed that the illustrated embodiment performs according to the latter approach. Thus, in the embodiment of FIG. 2, text-to-speech driver unit 121 is configured to receive punctuated text data from controller 120, to identify data symbols representative of punctuation from the punctuated text data and to form a punctuation information signal representative of the punctuation identified in the received punctuated text data.

As described in connection with FIG. 1, the text-to-speech driver unit 121 is further configured to process the received punctuated text data to form a synthetic speech signal and to provide the synthetic speech signal to the audio output unit 116. The text-to-speech output driver unit 121 is also configured to provide the punctuation information signal to the tactile output unit 117 to produce a perceivable tactile output representative of the punctuation identified in the punctuated text data, as previously described. In an embodiment of the invention, text-to-speech output driver unit 121 is configured to control audio output unit 116 and tactile output unit 117 to synchronise the perceivable tactile output produced by the tactile unit with the audible speech signal produced by the audio output unit.

Audio output unit 116 is configured to produce an audible speech signal representative of the punctuated text data responsive to the received synthetic speech signal.

Tactile output unit 117 is configured to produce a tactile output representative of the punctuation of the text responsive to the received punctuation information signal. The tactile feedback may provide tactile sensation to a user. According to an embodiment, tactile stimulus varies according to punctuation marks. According to another embodiment memory block of a device includes a table of different punctuation marks and corresponding tactile outputs. Tactile output may comprise, but is not limited to, short pulses, longer pulses, dense or non-dense vibration, and any variation of those including patterns comprising different tactile pulses and/or timed pauses in between the tactile pulses. Tactile output may be implemented using one or several outputs. According to an embodiment a body of the device is vibrating as a response to punctuation information signal. According to another embodiment several tactile stimulators are activated as a response to a punctuation information signal. Tactile stimulators may be attachable, to a skin of a user for example.

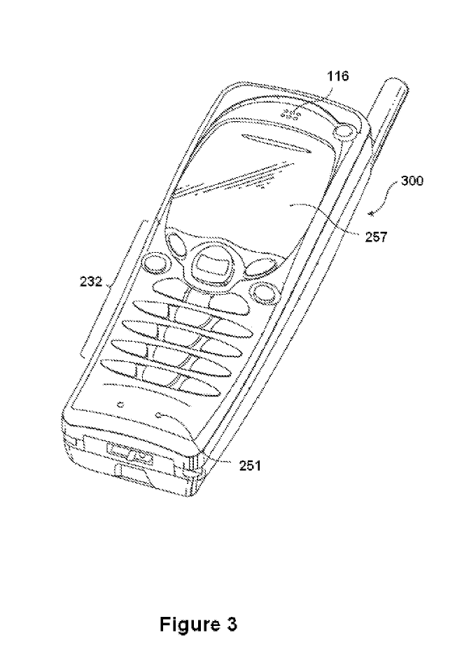

FIG. 3 illustrates an external three dimensional view of electronic device 230 according to an embodiment of the present invention.

The input unit 111 is configured to receive punctuated text data and to transmit the text data to memory 122. Punctuated text data may be input by the user via the keyboard 232 or by way of receipt from the communications network via the transceiver 214. The radio transceiver 214 is configured for receiving punctuated text data in the form of SMS messages or e-mails.

The memory 122 is configured to store the punctuated text data, the controller is configured to read punctuated text data from the memory 122, and is configured to process said punctuated text data once it has been read. Having read punctuated text data from the memory 122, the controller 120 is configured to provide it as an input to the output unit 123. The output unit 123 is configured to convert punctuated text data to audio output and to convert said identified punctuation to tactile output.

The output driver is configured to receive input 27 from the controller 120, to operate the loudspeaker 116, and to operate the tactile actuator 117. The controller 120 is configured to process punctuated text data and to identify punctuation in said punctuated text data. The process of punctuation identification is described in more detail with regard to FIGS. 5 and 6. The loudspeaker 116 is configured to generate the audio output, and the tactile actuator 117 is configured to generate the tactile output.

The controller 120 is configured to control the display driver 255, and thereby to operate the display 257, for example, in order to present the punctuated text data. In a further example, an encoded speech signal may be received by a transceiver 214, and may be decoded by the audio component 252 under control of the controller 120. The decoded digital signal may be converted to an analogue signal 258 by a digital to analogue converter, which is not shown, and output by loudspeaker 116. The microphone 251 may convert speech audio signals into a corresponding analogue signal which in turn may be converted from analogue to digital. The audio component 252 may then encode the signal and, under control of the controller 120, forward the encoded signal to the transceiver 253 for output to the communication network.

The audio output may comprise sound waves. The audio output may comprise synthetic speech.

FIG. 4 is a schematic illustration of the tactile actuator 117 that forms part of the apparatus 110 shown in FIG. 1. The tactile actuator 117 comprises a movable mass 431 and a base 432. The moveable mass 431 is moveable relative to the base 432 in at least one dimension. The tactile actuator 117 may comprise, for example, an eccentric rotating motor, a harmonic eccentric rotating motor, a solenoid, a resistive actuator, a piezoelectric actuator, an electro-active polymer actuator, or other types of active/passive actuators suitable for generating tactile output.

Force may be applied from the base 432 to the moveable mass 431 and in a similar fashion from the moveable mass 431 to the base 432. The force transfer can occur, for instance, via magnetic forces, spring forces, and electrostatic forces, piezoelectric forces, and mechanical forces.

The base 432 may be connected to the electronic device 230 shown in FIGS. 2 and 3, so that movement of the mass 431 causes forces to be generated between the mass 431 and the base 432, and these forces may be transmitted to the electronic device 230. For example the base 432 may be bonded to or integral with a housing of the electronic device 230, it may be located within the housing, so that movement of the mass may cause the housing of the electronic device 230 to vibrate thereby generating the tactile output.

The moving mass 431 may comprise, for instance, a permanent magnet, electromagnet, ferromagnetic material, and/or a combination of thereof. The base 432 may comprise, for instance, a permanent magnet, an electromagnet, ferromagnetic material, or any combination of these.

FIG. 5 shows a flow chart illustrating a method of punctuated text data processing according to one aspect of the present invention. Initiation of text processing occurs at block 500, for example by a user via a keyboard, if the controller detects that the process has been initiated, it reads punctuated text data from the memory. The punctuated text data is processed by the controller symbol by symbol, to identify whether the text symbol is a phoneme at block 502, or punctuation mark at block 503. If a phoneme is identified then, the phoneme is added, by the controller, which is configured to perform this operation, to a phoneme stream at block 504. If a punctuation mark is identified, then it may be added, by the controller, which is configured to perform this operation, to the phoneme stream at block 505, and an incremental time Tᵢ is calculated, by the controller, which is configured to perform this operation, at block 507, and the punctuation is also added, by the controller, which is configured to perform this operation, to the punctuation stream at block 507. The memory is configured to store the phoneme stream, and punctuation stream.

A punctuation mark may be intended to affect such audio properties as tone, pitch, and volume associated with the punctuated text data. Therefore, in the FIG. 5 process, punctuation is put to the phoneme stream, as well as the punctuation stream.

The extent to which the required text has been processed is determined, by the controller 120, at block 509, and if all the text has been processed then the FIG. 5 process is terminated by the controller 120.

Once the incremental times Tᵢ have been calculated, and the phoneme stream, together with the punctuation stream have been generated, by the process shown in FIG. 5, then the process illustrated in FIG. 6 is initiated by the controller 120. FIG. 6 depicts, at block 603, the audio stream and, at block 604, the punctuation stream being read by the output driver 121, for each incremental time interval Tᵢ, if, at block 605, no punctuation is detected at Tᵢ then only audio output is generated for the phoneme, at block 606, by the output unit 123, however, if punctuation is detected, then at block 609, tactile output is generated, the tactile output being generated by the output unit 123. The process is repeated, by returning to block 601, for each Tᵢ until all the required punctuated text data, as determined at block 602, has been processed by the output driver 121. A single timer, which forms part of the output driver 121, and which is not shown in the diagrams, is used to run through both streams during output, which ensures that the streams are synchronized.

The times Tᵢ are calculated for a phoneme stream that is read at a pre-determined rate. When the phoneme stream is read at this rate the timer is configured to ensure that tactile output is generated at a time corresponding to the location of the punctuation in the punctuated text data.

The output unit 123 is configured to generate audio output for each phoneme present in the stream. The output driver 121 is configured to, when it reads to a phoneme, operate the loudspeaker 116 to generate corresponding audio output. The output unit 123 is configured to generate tactile output for each punctuation mark present in said punctuation stream. The output driver 121 is configured to, when it reads a punctuation, operate the tactile actuator 117, to generate corresponding tactile output.

The process described in FIGS. 5 and 6 involves the generation of a phoneme stream, together with a punctuation stream, and the calculation of a number of incremental times Tᵢ. The punctuation and phoneme streams are stored in memory 121, and are then read, tactile output being generated at intervals Tᵢ. However, in a further embodiment of the invention, tactile output may be generated as each punctuation is read, and audio output may be generated as each phoneme is read, without a requirement to store the phoneme or punctuation streams. According to another embodiment of the invention, audio output is generated either after a formed phoneme stream is read from the memory, or right after a phoneme is read, i.e. on the fly. According to the embodiment, punctuation information is identified from the data. Punctuation information may be stored as a list, stack or using any suitable storing means and structure. In one example, punctuation data is saved in first-in-first-out (FIFO) structure. In this example, when data is outputted, any punctuation mark triggers next punctuation item in the FIFO memory to be processed. In an example embodiment punctuation item is fetched, corresponding signal is formed or fetched, and the signal responsive to the punctuation item is transmitted to the tactile actuator(s) to be outputted.

According to an embodiment a computer-readable storage medium encoded with instructions that, when executed by a computer, causes performance of processing punctuated text data; identifying punctuation in said punctuated text data; converting said punctuated text data to audio output; and converting said identified punctuation to tactile output.

Without in any way limiting the scope, interpretation, or application of the claims appearing below, it is possible that a technical effect of one or more of the example embodiments disclosed herein may be to improve the comprehension of TTS, by a user.

Embodiments of the present invention may be implemented in software, hardware, application logic or a combination of software, hardware and application logic. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus comprising:
a controller configured to process punctuated text data, and to identify punctuation in said punctuated text data; and
an output unit configured to generate audio output corresponding to said punctuated text data, and to generate tactile output corresponding to said identified punctuation.

2. An apparatus according to claim 1 wherein the controller is further configured to identify a phoneme in the punctuated text data; and to put said identified phoneme into a phoneme stream.

3. An apparatus according to claim 1 wherein the controller is further configured to identify a punctuation mark in said punctuated text data and to put it to at least one of a memory or a punctuation stream.

4. An apparatus according to claim 2, wherein the output unit is configured to generate audio output for a phoneme present in the phoneme stream.

5. An apparatus according to claim 3, wherein the output unit is configured to generate tactile output for a punctuation mark.

6. An apparatus according to claim 1, wherein said output unit comprises an output driver, a loudspeaker, and a tactile actuator, the output driver being configured to operate at least one of the loudspeaker, and the tactile actuator.

7. An apparatus according to claim 3 wherein the controller is configured to add the punctuation mark to the phoneme stream.

8. An apparatus according to claim 7 wherein the controller is configured to calculate an incremental time Ti for each identified punctuation mark, wherein, when the phoneme stream is read at a predetermined rate, the incremental time Ti is the time at which the punctuation mark appears in the phoneme stream.

9. A method comprising: processing punctuated text data; identifying punctuation in said punctuated text data; converting said punctuated text data to audio output; and converting said identified punctuation to tactile output.

10. A method according to claim 9 wherein the processing comprises identifying a phoneme in said punctuated text data and putting said phoneme to a phoneme stream.

11. A method according to claim 9 wherein said identifying punctuation comprises identifying a punctuation mark present in said punctuated text data and putting it to at least one of a memory and a punctuation stream.

12. A method according to claim 10 wherein said converting to audio output comprises generating audio output for a phoneme present in the punctuation stream.

13. A method according to claim 11 wherein said converting to tactile output comprises generating tactile output for a punctuation mark in the punctuation stream.

14. A method according to claim 9 wherein the method comprises reading said text data from a memory.

15. A method according to claim 9 wherein the method comprises inputting said text data to said apparatus.

16. A method according to 15 wherein said inputting said text data comprises receiving said text data using a radio receiver.

17. A method according to claim 9 wherein converting said audio output comprises synthetic speech.

18. A method according to claim 10 wherein the method comprises adding the punctuation mark to the phoneme stream.

19. A method according to claim 18 wherein the method comprises calculating an incremental time Ti for each identified punctuation mark, wherein, when the phoneme stream is read at a predetermined rate, the incremental time Ti is the time at which the punctuation mark appears in the phoneme stream.

20. A computer program product comprising a computer-readable medium bearing computer program code embodied therein for use with a computer, the computer program code comprising:
code for processing punctuated text data;
code for identifying a punctuation mark in said punctuated text data
code for converting said punctuated text data to audio output; and
code for converting said identified punctuation to tactile output.
